(19) United States
(12) Patent Application Publication
(10) Pub. No.: US 2007/0297765 A1
(43) Pub. Date: Dec. 27, 2007

(54) Reproducing apparatus for multiple AV streams and reproducing method for the same

(76) Inventor: Kaoru Ukai, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/811,689

(22) Filed: Jun. 12, 2007

(30) Foreign Application Priority Data
Jun. 22, 2006 (JP) P2006-172438

(51) Int. Cl. H04N 7/00

(52) U.S. Cl. 386/95

(57) ABSTRACT

According to one embodiment, a reproducing apparatus includes: a data acquisition device acquiring a plurality of object data constituted with a group of data units having reproduce time instant information, the reproduce time instant information of each of the object data being independent of each other; a rewriting device calculating offset time information being a difference between a reproduce time instant and a reference time instant of the object data and rewriting the reproduce time instant information of the object data to reproduce time instant information adjusted to the reference time instant by using the offset time information; and a reproduce processing device reproducing the object data in accordance with the reproduce time instant information rewritten by the rewriting device.

### CROSS-REFERENCE TO RELATED APPLICATIONS

This application is based upon and claims the benefit of priority from Japanese Patent Application Publication (KOKAI) No. 2006-172438, filed Jun. 22, 2006, the entire contents of which are incorporated herein by reference.

### BACKGROUND

1. Field

One embodiment of the invention relates to a reproducing apparatus for multiple AV streams and a reproducing method for the same.

2. Description of the Related Art

In recent years, as digitalization of audio video information (AV information) progresses, a medium recording MPEG-encoded AV information is becoming commonly used. As a representative example of such a medium, there can be cited a DVD (digital versatile disc). The DVD is progressing also in terms of its standard, and a standard called a HD-DVD (high definition DVD) is being developed as a high-vision compatible DVD standard. Since a recording density is substantially increased in the HD-DVD standard than in a current DVD, a reproducing apparatus is also required to be sophisticated to correspond thereto. In other words, though only one program stream can be reproduced in a current DVD video standard, it is essential in the HD-DVD standard that program streams of two systems (a primary program stream constituting a primary video set and a secondary program stream constituting a secondary video set) having been separately multiplexed and having no time relation can be synchronously reproduced.

More specifically, in an HD-DVD standard optical disc, there are recorded a main video signal, a sub video signal, a main audio signal, a sub audio signal and a sub picture signal as primary program streams, and an HD-DVD standard optical disc reproducing apparatus is configured to be able to reproduce these five kinds of primary program streams selectively.

Further, the HD-DVD standard reproducing apparatus is able to acquire a main video signal, a sub video signal, a main audio signal, and a sub audio signal as secondary program streams from a server via a network, and is configured to be able to selectively replace the sub video signal, the main audio signal and/or the sub audio signal acquired from the optical disc to the sub video signal, the main audio signal and/or the sub audio signal acquired from the server and to perform a synchronous reproducing.

Incidentally, it is conventionally known that different data (video and audio, or video and sub picture) in one program stream are synchronously reproduced (See Japanese Patent Application Publication (KOKAI) No. 2004-228627).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing substantial parts of a reproducing apparatus for multiple AV streams according to a first embodiment of the invention;

FIG. 2 is an exemplary diagram showing a data structure of multiple AV streams in the embodiment;

FIG. 3 is an exemplary flowchart showing reproduce processings of multiple AV streams according to the first embodiment;

FIG. 4 is an exemplary diagram explaining the reproduce processings of multiple AV streams according to the first embodiment;

FIG. 5 is an exemplary diagram showing substantial parts of a reproducing apparatus for multiple AV streams according to a second embodiment of the invention;

FIG. 6 is an exemplary flowchart showing reproduce processings of multiple AV streams according to the second embodiment;

FIG. 7 is an exemplary diagram explaining the reproduce processings of multiple AV streams according to the second embodiment; and

FIG. 8 is an exemplary diagram showing substantial parts of a reproducing apparatus for multiple AV streams according to a modification example in the embodiment.

### DETAILED DESCRIPTION

Various embodiments according to the invention will be described hereinafter with reference to the accompanying drawings. In general, according to one embodiment of the invention, a reproducing (playing) apparatus includes: a data acquisition device acquiring a plurality of object data constituted with a group of data units having reproduce time instant information, the reproduce time instant information of each of the object data being independent of each other; a rewriting device calculating offset time information being a difference between a reproduce time instant and a reference time instant of the object data and rewriting the reproduce time instant information of the object data to reproduce time instant information adjusted to the reference time instant by using the offset time information; and a reproduce processing device reproducing the object data in accordance with the reproduce time instant information rewritten by the rewriting device.

A reproducing method includes: acquiring a plurality of object data constituted with a group of data units having reproduce time instant information, the reproduce time instant information of each of the object data being independent of each other; calculating offset time information being a difference between a reproduce time instant and a reference time instant of the object data and rewriting the reproduce time instant information of the object data to reproduce time instant information adjusted to the reference time instant by using the offset time information; and reproducing the object data in accordance with the rewritten reproduce time instant information.

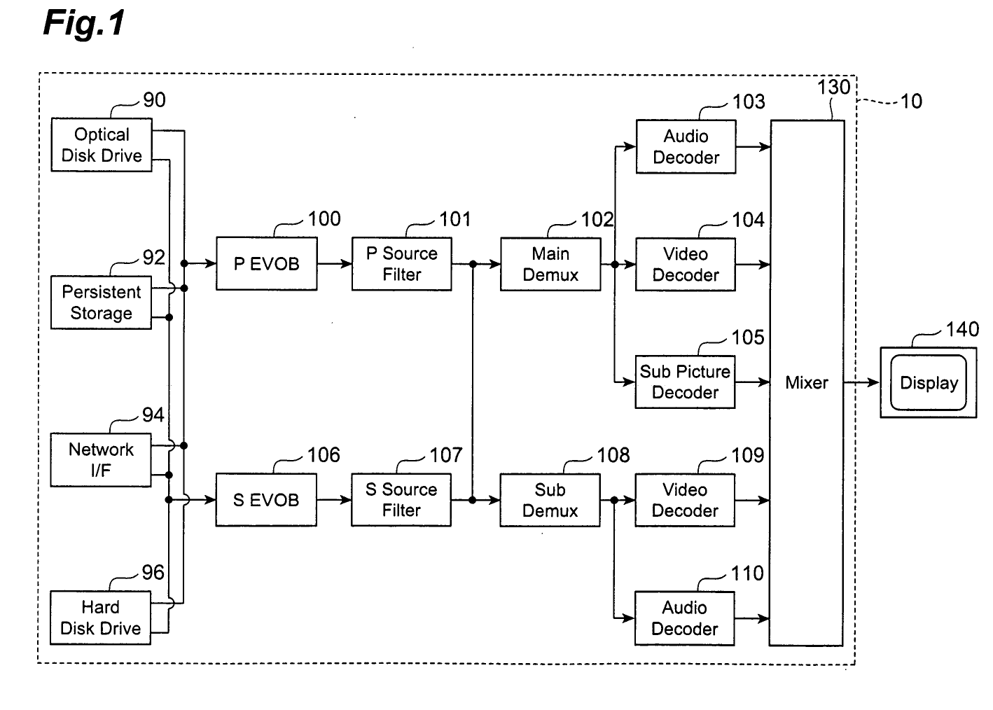

FIG. 1 is a diagram showing substantial parts of a reproducing apparatus 10 for multiple AV streams according to a first embodiment of the invention. Here, it is configured that multiple AV streams complying with the HD-DVD standard can be retrieved from one or more of an optical disc drive 90 in which a blue laser or the like is used, a persistent storage 92 in which a large capacity flush memory or the like is used, a network interface (network I/F) 94 configured to be connectable to a content provider via internet or the like, and a hard disk drive 96.

Input data (multiple AV streams) to the reproducing apparatus 10 of FIG. 1 are provided as a primary enhanced video object (hereinafter, referred to as P-EVOB) 100 and a secondary enhanced video object (hereinafter, referred to as S-EVOB) 106. These data are buffered by a primary source filter 101 and a secondary source filter 107 respectively, and thereafter provided to a main demultiplexer (main demux) 102 and a sub demultiplexer (sub demux) 108. Here, main data in the P-EVOB are transmitted to the main demux 102 while sub data are transmitted to the sub demux 108. Similarly, main data in the S-EVOB are provided to the main demux 102 while sub data are provided to the sub demux 108. The data demultiplexed by the main demux 102 and the sub demux 108 are transmitted to main decoders 103 to 105 and sub decoders 109, 110 respectively and then decoded.

Among the main decoders 103 to 105 and the sub decoders 109, 110, the decoders 104 and 109 for the video decode video information encoded by methods such as MPEG2, MPEG4 and VC-1. The decoders 103, 110 for the audio decode audio information encoded by methods such as AC-3 (R), DTS (R) and L-PCM in addition to MPEG. The decoder 105 for the sub picture decodes bitmap information encoded by a method (run-length compression using a special code) specified in the HD-DVD standard.

A mixer 130 imports video data, audio data and sub picture data from the main decoders 103 to 105 and sub decoders 109, 110 and outputs a video output signal and an audio output signal generated based on the imported data to a display 140. The display 140 imports the video output signal and the audio output signal, and reproduces a moving image based on the video output signal and reproduces a sound from a speaker based on the audio output signal.

In the configuration stated above, the optical disc drive 90, the persistent storage 92, the network I/F 94 and the hard disc drive 96 are acquisition devices for acquiring the multiple AV streams. The main demux 102 and the sub demux 108 are rewriting devices for a rewriting into reproduce time instant information. The main decoders 103 to 105, the sub decoders 109, 110 and the mixer 130 in subsequent blocks of main demux 102 and the sub demux 108 are reproduce processing devices for reproducing object data in accordance with the reproduce time instant information.

In the reproducing in FIG. 1, in addition to a normal reproduce (play), there are reproduce modes such as a slow reproduce, a reproduce pause, a step reproduce, a fast-forward (FF) reproduce and a fast-reverse (FR) reproduce. In these reproduce modes, there exist STC control states such as of normal, slow, pause and step, and STC noncontrol states (STC free states) such as of fast-forward and fast-reverse. The STC control state is a mode in which the reproducing is performed with reference to an STC while the STC noncontrol state (STC free state) is a mode in which the reproducing is performed without reference to the STC. In the HD-DVD, since synchronism of the main data and the sub data is to be acquired, it is necessary to acquire synchronism also at a time of the STC noncontrol state (STC free state) to perform reproducing.

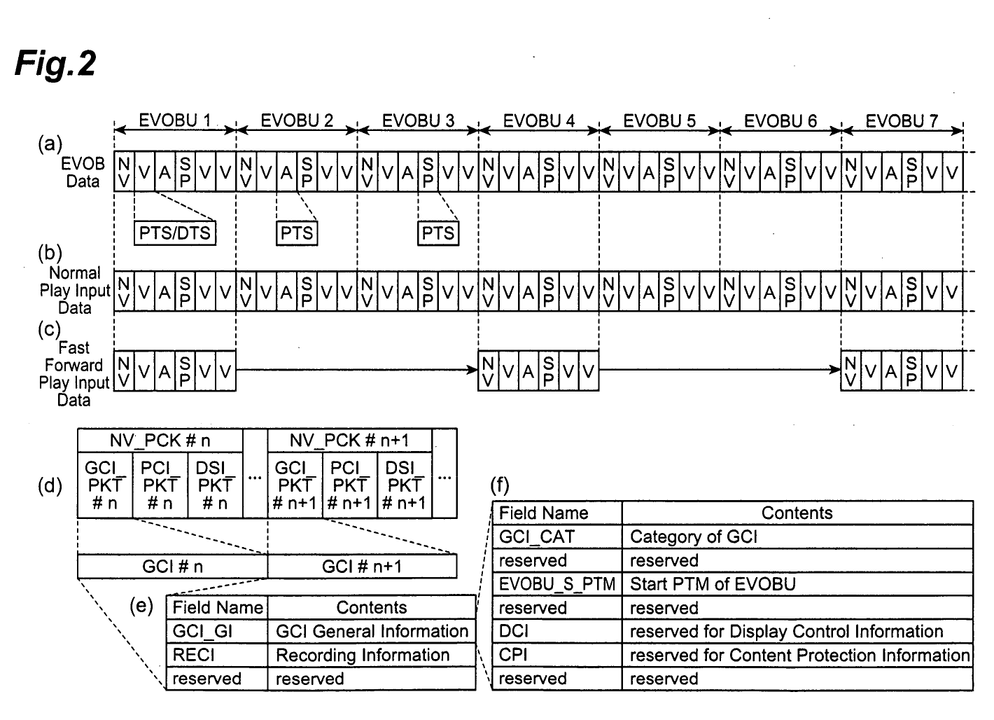

FIG. 2 is a diagram showing a data structure of the multiple AV streams reproduced by the reproducing apparatus 10 of FIG. 1. Each EVOB is constituted with a group of a plurality of data units (enhanced video object unit: EVOBU)(FIG. 2(a)). At a beginning of each EVOBU is disposed a navigation pack NV, and therebehind are appropriately disposed a predetermined number of video pack(s) V, audio pack(s) A and sub picture pack(s) SP. Each EVOBU has a size equivalent to a reproduce time instant of 0.4 to 1.001 seconds (note that an EVOBU at the end of the EVOB has a size equivalent to a reproduce time instant of 0.4 to 1.2012 seconds). The optical disc drive 90 of FIG. 1 is configured to be able to access to any EVOBU from the NV pack of its beginning. At a time of the normal reproduce, the respective EVOBUs are sequentially reproduced (FIG. 2 (b)), while at a time of fast-forward reproduce, parts of the EVOBUs are reproduced at intervals (for example, at a rate of one EVOBU per three EVOBUs) (FIG. 2 (C)).

As the multiple AV streams, there are program streams of a plurality of systems separately multiplexed and having no time relation, and in a case of the HD-DVD standard, there are primary program streams constituting a primary video set and secondary program streams constituting a secondary program set. As the primary program streams, there are a main video stream, a main audio stream, a sub video stream, a sub audio stream, a sub picture stream and an advanced stream. As the secondary program streams, there are a main video stream, a main audio stream, a sub video stream and a sub audio stream. Each of these streams completes within one object (enhanced video object: EVOB).

Both in a case of the primary video set and in a case of the secondary video set, the main/sub video streams are stored in the video pack V and main/sub audio streams are stored in the audio pack A. Similarly, the sub picture stream is stored in the audio pack A. The video pack V has a header including a reproduce (play) time stamp PTS and a decode time stamp DTS, the audio pack A has a header including a reproduce time stamp PTS, and the sub picture pack SP also has a header including a reproduce time stamp PTS.

In the navigation pack NV (NV_PCK#n in FIG. 2 (d)) disposed at the beginning of each EVOBU, general control information GCI is recorded, the GCI having general information GCI_GI (FIG. 2 (e)) thereof. In the GCI_GI are included information EVOBU_S_PTM indicating a reproduce start time instant, display control information, content protection information (copy control information) CPI and the like of the EVOBU having the NV pack including the GCI_GI at the beginning (FIG. 2 (f)).

The reproduce time instant information (EVOBU_S_PTM) in the above GCI, and the reproduce time instant information (PTS, DTS) in the V pack, the A pack and the SP pack indicate time instants at which the information including those are scheduled to be reproduced. For the synchronous reproducing of the information (P-EVOB) of the primary video set and the information (S-EVOB) of the secondary video set, the reproduce time instant information (EVOBU_S_PTM) in the above GCI can be used. For the synchronous reproducing between the main/sub video streams and main/sub audio streams, the reproduce time instant information (PTS, DTS) in the packs (V pack, A pack) storing these streams can be used. It should be noted that a definition of the reproduce time instant information in the present embodiment includes the decode time stamp DTS since the decode time stamp DTS is one of the time stamps used for reproducing the multiple AV streams.

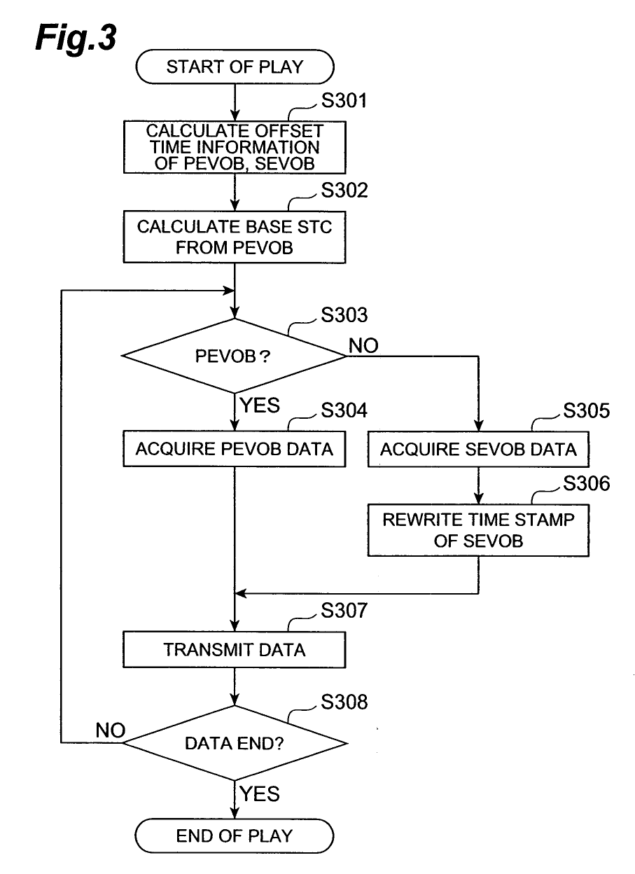

FIG. 3 is a flowchart showing a synchronous reproduce processings in the reproducing apparatus 10 of FIG. 1.

The main demux 102 extracts from the main data of the P-EVOB reproduce time instant information EVOBU_S_PTM recorded in a navigation pack of the main data of the P-EVOB. Further, the main demux 102 extracts from the main data of the S-EVOB reproduce time instant information EVOBU_S_PTM recorded in a navigation pack of the main data of the S-EVOB. Then, the main demux 102 subtracts the reproduce time instant information EVOBU_S_PTM extracted from the S-EVOB from the reproduce time instant information EVOBU_S_PTM extracted from the P-EVOB, and whereby the main demux 102 acquires offset time information Offset_Time being a difference between the two reproduce time instant information EVOBU_S_PTM (S301).

Next, the main demux 102 calculates a base STC based on the reproduce time instant information EVOBU_S_PTM extracted from the main data of the P-EVOB (S302). Here, the base STC is time instant information which is based on the reproduce time instant information EVOBU_S_PTM extracted from the main data of the P-EVOB and is increased in correspondence with a clock. The base STC is outputted to the main decoders 103 to 105, the sub decoders 109, 110 and the mixer 130 and used for synchronizing the reproduce processings.

Here, the processings of S301 and S302 described above are performed at non-seamless connection points existing in the middles of the P-EVOB and the S-EVOB. The non-seamless connection point is a timing in which a breakless reproducing is not required, and for the P-EVOB and the S-EVOB it is treated as the data end when the non-seamless connection point is reached. Thus, for the P-EVOB and the S-EVOB, a flow of FIG. 3 once ends when the non-seamless connection point is reached, and immediately thereafter the flow of FIG. 3 starts again so that the processings of S301 and S302 described above are performed.

Next, the main demux 102 judges whether or not the main data to process are those having been included in the P-EVOB (S303). Here, if the main data to process is judged to be those having been included in the P-EVOB, the main demux 102 acquires the main data of the P-EVOB and thereafter transmits the acquired main data as they are to the decoder (S304, S307).

On the other hand, if the main data to process are judged not to be those having been included in the P-EVOB in S303, the main data to process are those having been included in the S-EVOB, and so the main demux 102 retrieves the main data of the S-EVOB and thereafter rewrites a time stamp included in the acquired main data of the S-EVOB with new reproduce time instant information calculated by adding the offset time Offset_Time to the reproduce time instant of the time stamp (S305, S306). The new reproduce time instant information is information adjusted to a reference time instant, with the reproduce time instant information EVOBU_S_PTM of the P-EVOB being the reference time instant.

Here, the main demux 102 rewrites the reproduce time instant information EVOBU_S_PTM included in the NV pack, the reproduce time instant information PTS, DTS included in the V pack, the reproduce time instant information PTS included in the A pack, and the reproduce time instant information PTS included in the SP pack, as the time stamp included in the main data of the S-EVOB. Then, the main demux 102 transmits the main data of the S-EVOB in which the time stamps are rewritten to the main decoders 103 to 105 (S307).

Next, the main demux 102 judges whether or not the data to reproduce end (S308). Here, if the data to reproduce do not end yet, the main demux 102 repeats the processings of S303 to S307. On the other hand, if all the data to reproduce end, the main demux 102 terminates the reproduce processings of the data.

It should be noted that the synchronous reproduce processings described above are performed similarly aLso in the sub demux 108. In other words, the sub demux 108 rewrites a time stamp included in sub data of the S-EVOB with new reproduce time instant information calculated by adding an offset time Offset_Time to a reproduce time instant of the time stamp.

In the synchronous reproduce processings described above, with the time stamp included in the P-EVOB being the reference time instant, the time stamp included in the S-EVOB is rewritten in a manner that the time stamp included in the S-EVOB is adjusted to the time stamp included in the P-EVOB. It should be noted, however, that the time stamp included in the P-EVOB can be rewritten in a manner that the time stamp included in the P-EVOB is adjusted to the time stamp included in the S-EVOB, with the time stamp included in the S-EVOB being the reference time instant.

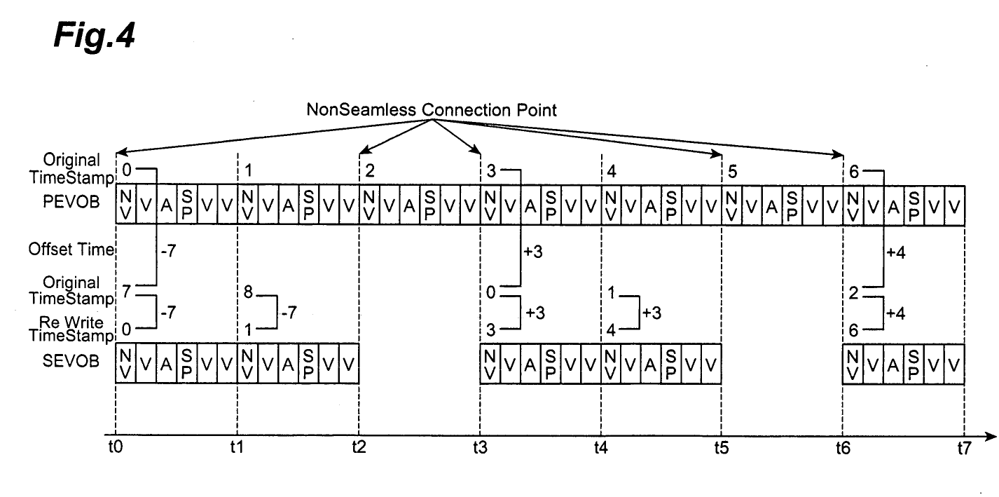

FIG. 4 is a time chart showing an example of the synchronous reproduce processings of FIG. 3.

The P-EVOB is continuously reproduced during a time t0 a time t7. On the other hand, the S-EVOB is reproduced intermittently during the time t0 to the time t7. The S-EVOB is reproduced during the time t0 to the time t2, during the time t3 to the time t5, and during the time t6 to the time t7. Since the P-EVOB is reproduced continuously, the time stamps (original time stamps) of the P-EVOB are continuous. On the other hand, the time stamps (original time stamps) of the S-EVOB lack continuity at a point at which the reproducing of the S-EVOB ceases. For the P-EVOB and the S-EVOB, the times t0, t2, t3, t5, and t6 are non-seamless connection points.

At the time t0, the main demux 102 and the sub demux 108 subtract a time stamp “7” of the S-EVOB from a time stamp “0” of the P-EVOB and calculates “−7” as an offset time. Then, the main demux 102 and the sub demux 108 rewrite a time stamp of an S-EVOBU to a value “0” which is calculated by adding the offset time “−7” to the original time stamp “7” of the S-EVOBU. Thereafter, also at the time t1, the main demux 102 and the sub demux 108 rewrite a time stamp of an S-EVOBU to a value “1” calculated by adding the offset time “−7” to an original time stamp “8” of the S-EVOBU.

At the time t3, the main demux 102 and the sub demux 108 recalculate the offset time. In other words, the main demux 102 and the sub demux 108 subtract a time stamp “0” of the S-EVOB from a time stamp “3” of the P-EVOB and calculates “3” as an offset time. Then, the main demux 102 and the sub demux 108 rewrite a time stamp of an S-EVOBU to a value “3” calculated by adding the offset time “3” to the original time stamp “0” of the S-EVOBU. Thereafter, also at the time t4, the main demux 102 and the sub demux 108 rewrite a time stamp of an S-EVOBU to a value “4” calculated by adding the offset time “3” to an original time stamp “1” of the S-EVOBU.

At the time t6, the main demux 102 and the sub demux 108 recalculate the offset time. In other words, the main demux 102 and the sub demux 108 subtract a time stamp “2” of the S-EVOB from a time stamp “6” of the P-EVOB and calculates “4” as an offset time. Then, the main demux 102 and the sub demux 108 rewrite a time stamp of an S-EVOBU to a value “6” calculated by adding the offset time “4” to the original time stamp “2” of the S-EVOBU. It should be noted that in the example of the synchronous reproduce processings shown in FIG. 4, values of the time stamps are simplified for the sake of convenience of description.

In the reproducing apparatus 10 of the present embodiment described above, since the time stamp included in the S-EVOB is rewritten by the main demux 102 and the sub demux 108, it is possible to make the time stamp included in the P-EVOB and the time stamp included in the S-EVOB adjusted to the common reference time instant. Therefore, processing units in the following blocks such as a decoder are not required to perform processings in consideration of the difference between the time stamp included in the P-EVOB and the time stamp included in the S-EVOB and can perform decoding at a timing of the decode time stamp DTS and perform outputting at a timing of the reproduce time stamp PTS with reference to the above reference time instant, and whereby the synchronous reproducing of the multiple AV streams can be facilitated.

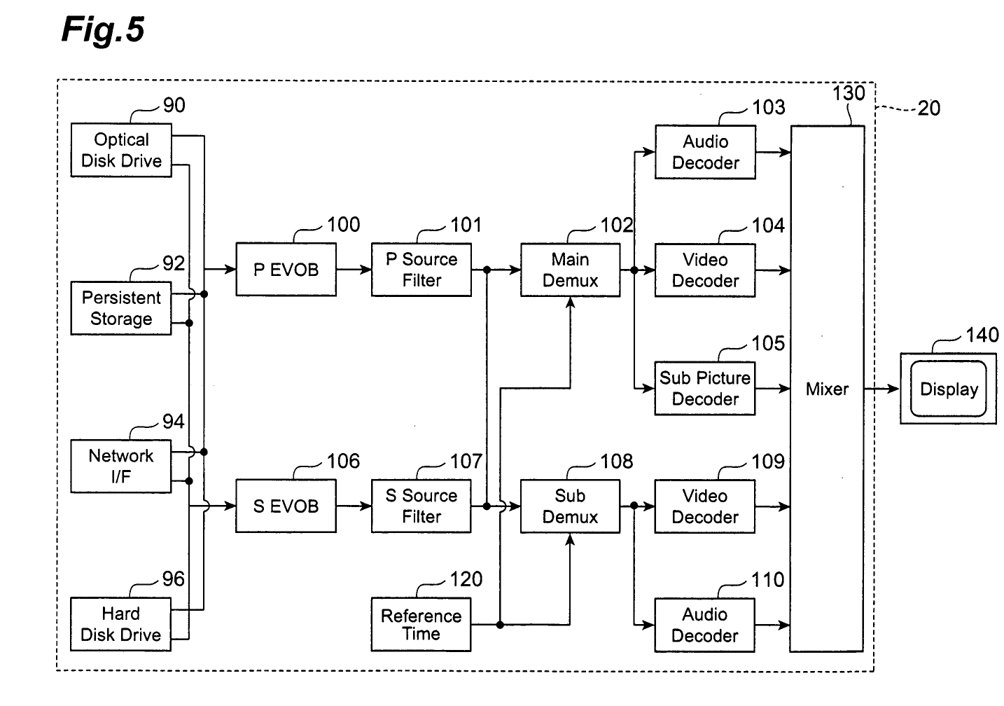

Next, a reproducing apparatus for multiple AV streams according to a second embodiment will be described. FIG. 5 is a diagram showing substantial parts of a reproducing apparatus 20 for multiple AV streams according to the second embodiment. In the reproducing apparatus 20 according to the second embodiment, reference time instant information has been inputted in a main demux 102 and a sub demux 108. Here, the reference time instant information is information indicating a reproduce elapsed time timed from start of reproducing of the multiple AV streams, and more specifically, information indicating a time elapsed from a time that a reproduce button of the reproducing apparatus 20 is pressed by a user.

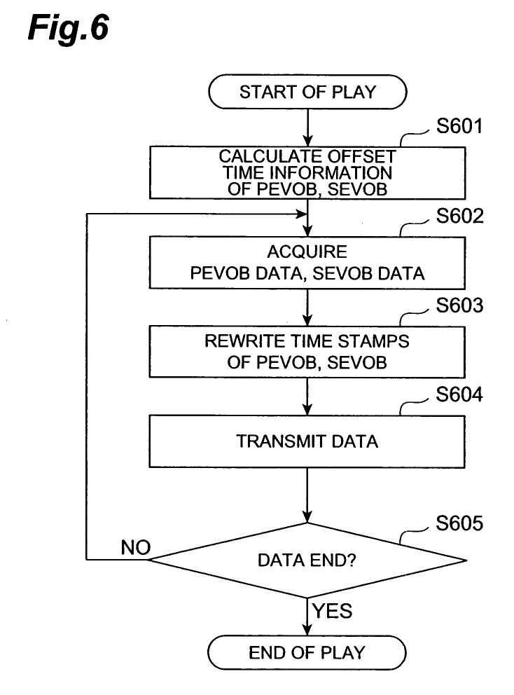

FIG. 6 is a flowchart showing synchronous reproduce processings in the reproducing apparatus 20 of FIG. 5. It should be noted that in a following description, a clip means data cut from either one of P-EVOB and S-EVOB, and is a data unit including a plurality of EVOBUs. A segment means a data unit including a plurality of clips.

The main demux 102 imports data of a clip existing in any place of a segment, and extracts a time stamp EVOBU_S_PTM recorded in a navigation pack at a beginning of the clip as reproduce time instant information First_Time_Stamp. Then, the main demux 102 performs a computation of a following formula (I) by using information Segement_Start_Time indicating a time that reproducing of the segment starts, information Segment_Reproducing_Time (Segment_Playing_Time) indicating a time elapsed from a time that the reproducing of the segment starts, and the reproduce time information First_Time_Stamp being the time stamp EVOBU_S_PTM of the beginning of the extracted clip, and calculates offset time information Offset_Time (S601).

Offset_Time=Segment_Start_Time+Segment_Reproducing_Time−First_Time_Stamp (1)

Here, the segment reproduce start time instant Segment_Start_Time is calculated with reference to the reference time instant information. The segment reproducing time Segment_Reproducing_Time is calculated by accumulating reproduce times of the clips already reproduced. Thus, a value calculated by adding the segment reproduce start time instant Segment_Start_Time and the segment reproducing time Segment_Reproducing_Time is the reproduce elapsed time instant Reference_Time at the beginning of the clip to process. In other words, the offset time Offset_Time represents a difference between the reproduce time instant EVOBU_S_PTM and the reproduce elapsed time instant Reference_Time concerning the beginning of the clip to process.

The processing of S601 described above is performed at a time that the clip changes. In other words, it is treated that the data end at the time that the clip changes, and a flow of FIG. 6 is terminated once. Then, the flow of FIG. 6 starts again in response to an immediately subsequent clip and the above processing of S601 is performed.

Next, after the main demux 102 acquires the data of the clip, the main demux 102 rewrites the time stamp included in the acquired data with new reproduce time instant information calculated by adding the offset time Offset_Time to the reproduce time instant EVOBU_S_PTM of the time stamp (S602, S603). The new reproduce time instant information is adjusted to a reference time instant, with the reproduce elapsed time instant Reference_Time being the reference time instant.

Here, the main demux 102 rewrites reproduce time instant information EVOBU_S_PTM included in an NV pack, reproduce time instant information PTS, DTS included in a V pack, reproduce time instant information PTS included in an A pack and reproduce time instant information included in an SP pack, as the time stamps. Then, the main demux 102 transmits the data whose time stamps are rewritten to main decoders 103 to 105 (S604).

Next, the main demux 102 judges whether or not the data to reproduce end (S605). Here, if the data to reproduce do not end yet, the main demux 102 repeats the processings from S602 to S604. On the other hand, if all the data to reproduce end, the main demux terminates the reproduce processings of the data.

It should be noted that the synchronous reproduce processings described above are performed similarly also in the sub demux 108. In other words, also in the sub demux 108, an offset time Offset_Time is calculated every time data of a clip are imported and a time stamp included in the data of the clip is rewritten to reproduce time instant information calculated by adding the offset time Offset_Time.

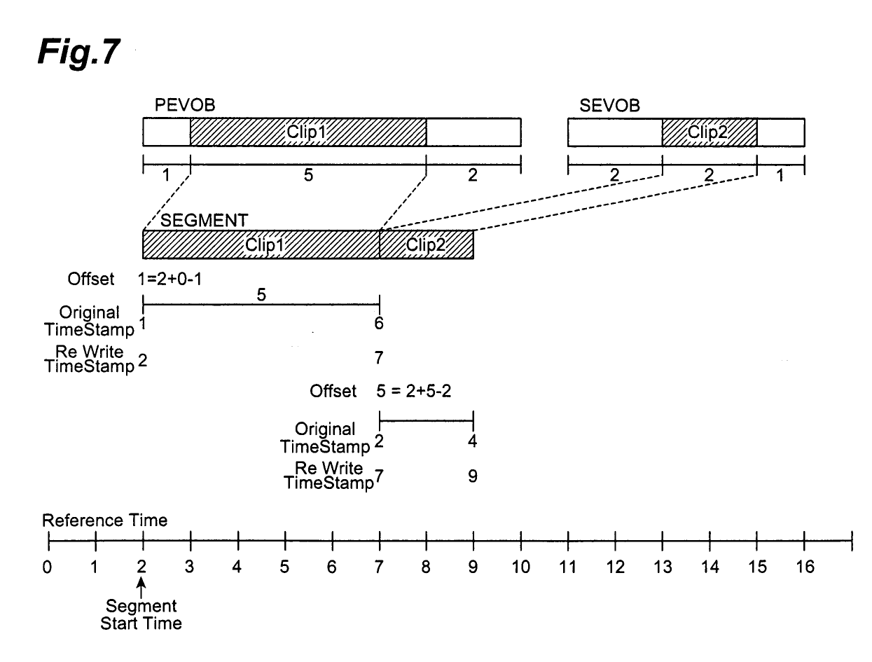

FIG. 7 is a time chart showing an example of the synchronous reproduce processings of FIG. 6.

In the example shown in FIG. 7, there is reproduced a segment in which a clip 1 being a part of the P-EVOB and a clip 2 being a part of the S-EVOB are connected. After the main demux 102 and the sub demux 108 import data of the clip 1, the main demux 102 and the sub demux 108 calculate an offset time for the clip 1 in accordance with the above formula (I). In other words, the main demux 102 and the sub demux 108 add a segment reproducing period Segment_Reproducing_Period “0” to a segment start time instant Segment_Start_Time “2”, and thereafter subtract a time stamp First_Time_Stamp “1” recorded in a navigation pack of a beginning of the clip 1, and whereby calculates an offset time Offset_Time “1”.

Then, the main demux 102 and the sub demux 108 calculate a new time stamp Rewrite_Time_Stamp “2” by adding the offset time Offset_Time “1” to a time stamp Original_Time_Stamp included in the clip 1 and rewrite the time stamp Original_Time_Stamp included in the clip 1 to the new time stamp Rewrite_Time_Stamp “2”. Similarly thereafter, the main demux 102 and the sub demux 108 calculate a new time stamp Rewrite_Time_Stamp by adding the offset time Offset_Time “1” to a time stamp Original_Time Stamp included in the clip 1 and rewrite the time stamp Original_Time_Stamp included in the clip 1 to the new time stamp Rewrite_Time_Stamp. At an end of the clip 1, a time stamp Original_Time_Stamp “6” is rewritten to a new time stamp Rewrite_Time_Stamp “7” calculated by adding the offset time Offset_Time “1” to the time stamp Original_Time_Stamp “6”.

Next, after the main demux 102 and the sub demux 108 import data of a clip 2, the main demux 102 and the sub demux 108 process the data of the clip 2 to calculate an offset time for the clip 2 in accordance with the above formula (I). In other words, the main demux 102 and the sub demux 108 add a segment reproducing period Segment_Reproducing_Peirod “5” to a segment start time instant Segment_Start_Time “2”, and thereafter subtract a time stamp First_Time_Stamp “2” recorded in a navigation pack at a beginning of the clip 2 to calculate an offset time Offset_Time “5”.

Then, the main demux 102 and the sub demux 108 calculate a new time stamp Rewrite_Time_Stamp “7” by adding the offset time “5” to a time stamp Original_Time_Stamp “2” included in the clip 2 and rewrite the time stamp Original_Time_Stamp “2” included in the clip 2 to the new time stamp Rewrite_Time_Stamp “7”. Similarly thereafter, the main demux 102 and the sub demux 108 calculate a new time stamp Rewrite_Time_Stamp by adding the offset time Offset_Time “5” to a time stamp Original_Time_Stamp included in the clip 2 and rewrite the time stamp Original_Time_Stamp included in the clip 2 to the new time stamp Rewrite_Time Stamp. At an end of the clip 2, a time stamp Original_Time_Stamp “4” is rewritten to a new time stamp Rewrite_Time_Stamp “9” by adding the offset time Offset_Time “5” to the time stamp Original_Time_Stamp “4”. It should be noted that in the example of the synchronous reproduce processings shown in FIG. 7, values of the time stamps are simplified for the sake of convenience of description.

In the above-described reproducing apparatus 20 of the second embodiment, the time stamps included in the P-EVOB and the S-EVOB are rewritten by the main demux 102 and the sub demux 108, and it is possible to make the time stamp included in the P-EVOB and the time stamp included in the S-EVOB adjusted to the common reference time instant. Therefore, the processing units in the following blocks such as a decoder are not required to perform processings in consideration of the difference between the time stamp included in the P-EVOB and the time stamp included in the S-EVOB and can perform decoding at a timing of the decode time stamp DTS and perform outputting at a time of the reproduce time stamp PTS with reference to the above reference time instant, and whereby the synchronous reproducing of the multiple AV streams can be facilitated.

Incidentally, in the above embodiments, the main demux 102 and the sub demux 108 rewrite the time stamp included in the P-EVOB or the time stamp included in the S-EVOB to a value larger than the time instant of the last frame of the EVOBU. The reason thereof is as follows. In an HD-DVD advanced, there is prepared a frame control being a function of performing a reproducing from a middle frame in the EVOBU. This frame control is realized by the decoder's acquiring all the frame data of the EVOBU and starting the reproducing from a designated reproduce start frame. Thus, if the main demux 102 and the sub demux 108 rewrite a time stamp of the reproduce start frame to “0”, a time stamp of a frame before the reproduce start frame becomes a value smaller than “0” and a processing by the decoder becomes difficult. In contrast, as stated above, if the time stamp included in the P-EVOB or the time stamp included in the S-EVOB is rewritten to a value larger than the time instant of the last frame of the EVOBU, the time stamp of the frame before the reproduce start frame can be made to be a value larger than “0”, and the processing by the decoder can be facilitated. More specifically, since the reproduce time of the EVOBU is 1.2012 at maximum, the time stamp of the reproduce start frame is made to be a value larger than 1.2012.

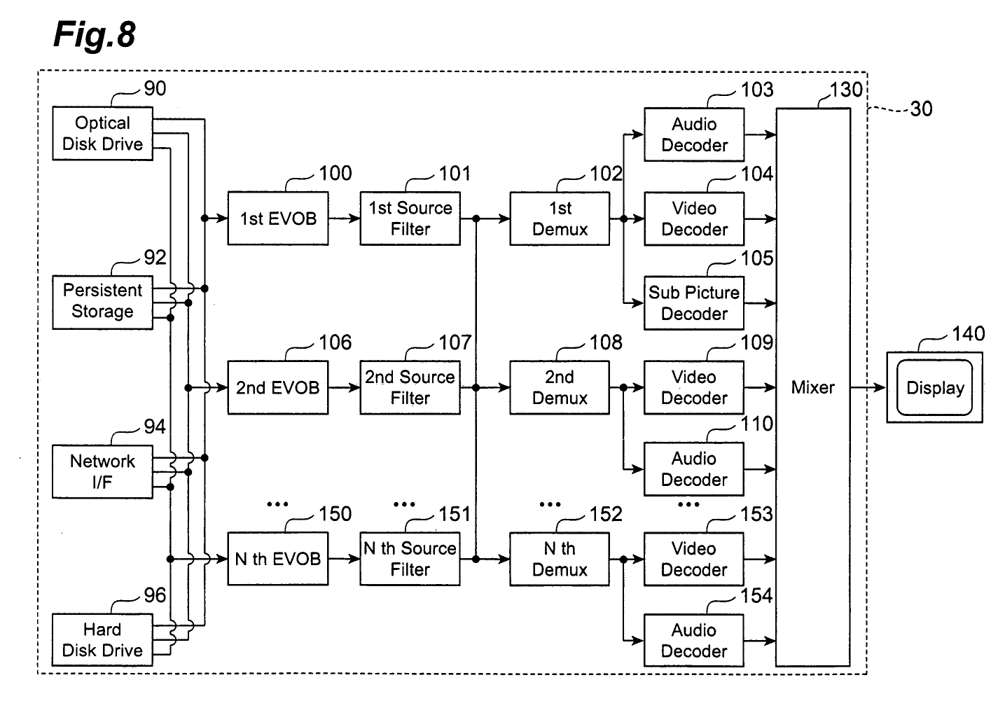

FIG. 8 is a diagram showing substantial parts of a reproducing apparatus 30 for multiple AV streams according to a modification example of the above-described embodiments. The reproducing apparatuses 10, 20 of the first embodiment and the second embodiment described above import and synchronously reproduce two AV streams (P-EVOB and S-EVOB) independent to each other in terms of time, but the present invention is not limited thereto. In other words, as shown in FIG. 8, the reproducing apparatus 30 can import and synchronously reproduce three or more AV streams (1st-EVOB, 2nd-EVOB, . . . , Nth-EVOB) independent to one another in terms of time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproducing apparatus comprising:
a data acquisition device configured to acquire a plurality of object data constituted with a group of data units having reproduce time instant information, the reproduce time instant information of each of the object data being independent of each other;
a rewriting device configured to calculate offset time information being a difference between a reproduce time instant and a reference time instant of the object data and to rewrite the reproduce time instant information of the object data to reproduce time instant information adjusted to the reference time instant by using the offset time information; and
a reproduce processing device configured to reproduce the object data in accordance with the reproduce time instant information rewritten by said rewriting device.

2. The reproducing apparatus according to claim 1,
wherein the reference time instant is the reproduce time instant of any one of the object data, and
wherein said rewriting device is configured to calculate the offset time information being the difference between the reproduce time instant of the any one of the object data and the reproduce time instant of another one of the object data, and to rewrite the reproduce time instant information of the another one of the object data to the reproduce time instant information adjusted to the reference time instant by using the offset time information.

3. The reproducing apparatus according to claim 1,
wherein the reference time instant is a reproduce elapsed time instant timed from a reproduce start of the object data, and
wherein said rewriting device is configured to calculate the offset time information being the difference between the reproduce time instant and the reproduce elapsed time instant of the each of the object data, and to rewrite the reproduce time instant information of the each of the object data to reproduce time instant information adjusted to the reference time instant by using the offset time information.

4. The reproducing apparatus according to claim 1,
wherein said rewriting device is configured to rewrite the reproduce time instant information of the object data to a value larger than a time required for a reproducing of one data unit.

5. The reproducing apparatus according to claim 1,
wherein the each of the object data includes main video data, main audio data, sub video data and sub audio data, and
wherein said rewriting device comprises a main demultiplexer to demultiplex each of the object data to sort the main video data and the main audio data, and a sub demultiplexer to demultiplex each of the object data to sort the sub video data and the sub audio data.

6. The reproducing apparatus according to claim 5,
wherein the main video data and the main audio data are encoded by a predetermined method,
and wherein said reproduce processing device is constituted including a main video decoder to decode the main video data and a main audio decoder to decode the main audio data.

7. The reproducing apparatus according to claim 5,
wherein the sub video data and the sub audio data are encoded by a predetermined method, and
wherein said reproduce processing device is constituted including a sub video decoder decoding the sub video data and a sub audio decoder decoding the sub audio data.

8. A reproducing method, comprising:
acquiring a plurality of object data constituted with a group of data units having reproduce time instant information, the reproduce time instant information of each of the object data being independent of each other;
calculating an offset time being a difference between the reproduce time instant and a reference time instant of the object data and rewriting the reproduce time instant information of the object data to reproduce time instant information adjusted to the reference time instant by using the offset time information; and
reproducing the object data in accordance with the rewritten reproduce time instant information.
